(19) United States
(12) Patent Application Publication
(10) Pub. No.: US 2016/0316719 A1
(43) Pub. Date: Nov. 3, 2016

(54) CYLINDRICAL SPINNING PET TOY AND TREAT DISPENSER

(71) Applicant: Michael Parness, Foxfield, CO (US)

(72) Inventor: Michael Parness, Foxfield, CO (US)

(21) Appl. No.: 14/698,760

(22) Filed: Apr. 28, 2015

(51) Int. Cl. A01K 15/02

(52) U.S. Cl. CPC A01K 15/025

(57) ABSTRACT

The invention relates to a novel pet toy and treat dispenser which may be filled with kibble and require a pet to roll the dispenser along a surface to cause kibble to randomly eject from various apertures in the toy and treat dispenser. Internal raised fins in the center section of the dispenser cause kibble to slide and thus tumble around the inside of the dispenser to further entice the pet to interact with the treat toy and dispenser.

### FIELD

The invention relates to a novel pet toy and treat dispenser wherein inserted treats are guided by internal fins toward exit apertures.

### BACKGROUND OF THE INVENTION

The invention most closely corresponds with USPTO Class 119/51.01 wherein Class 119 relates to animal husbandry and sub-class 51.01 includes feeding devices.

In its simplest form, the invention relates to a novel pet toy and treat dispenser wherein inserted treats are guided by internal fins toward exit apertures.

The toy and treat dispenser is tubular with a filling aperture at one end, and apertures for treat exit on the other end as well as located in the center of the tube portion.

When treats are inserted, a pet rolls or nudges the toy with its nose or a paw. Internal fins aid in cascading treat kibble through the tube and out one of several exit apertures.

### The Invention

### SUMMARY, OBJECTS AND ADVANTAGES

It is fairly well known in animal behavior sciences that dogs especially require some stimulation apart from human interaction. Thus, the dog toy market is a multi-billion dollar industry. Pet owners seek to encourage learning and cognition as well as to provide proper nutrition to their dogs.

It is also known that dogs do experience a sense of boredom, and if not addressed, may manifest in negative behavior such as chewing furniture or going to the bathroom in undesirable locations in the pet owner's home.

The inventive toy and treat dispenser addresses not only the dog's curiosity and huger sensations, it requires the dog to exhibit learned behavior. The dog must learn that to obtain a treat kibble within the dispenser, it must roll the dispenser along a surface until kibble exits one of several apertures in the dispenser toy.

Similar to Alzheimer's disease in humans, Canine Cognitive Dysfunction manifests in dogs primarily affecting memory, learning and comprehension. As with humans, there are exercises that are said to help stimulate and thus help avoid this dysfunction. Most certainly, entertained and challenged dogs are more alert and content than those who are not stimulated sufficiently.

The inventive toy and treat dispenser provides stimulation to the dog's sense of smell, visual acuity, and the reward acknowledgement. The dog can smell and see the kibble within the dispenser toy, and can also hear the kibble as it tumbles throughout.

The dog learns that unless it rolls the toy on a surface, no kibble will dispense. The dog can also begin to learn how much to roll the dispenser toy to obtain additional kibble. The protruding fins internal to the main cylinder shaft of the dispenser cause kibble to slide down and into the dispenser toy as it rolls causing a tumbling effect of the kibble that enhances the sound as well as aids in a metered dispense as kibble find its way out one of several apertures to the ground or floor surface.

### BRIEF DESCRIPTION OF THE DRAWINGS

The invention is described in further detail by reference to three (3) drawings sufficient in detail to describe the invention in which:

FIG. 1 shows the dispenser toy empty;

FIG. 2 shows the dispenser toy as being filled with treats; and

FIG. 3 is the dispenser toy being manipulated by a dog.

### DETAILED DESCRIPTION, INCLUDING BEST MODES OF CARRYING OUT THE INVENTION

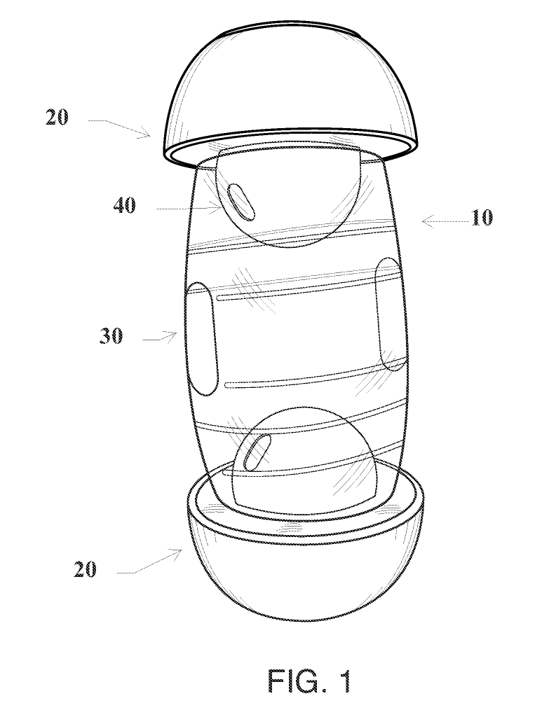

FIG. 1 shows the clear plastic dispenser toy center 10, and each end cap 20 of the dispenser toy. This configuration is suitable for a larger dog. Also illustrated in this Figure are the center portion apertures 30 which will allow kibble to be ejected therefrom when rolled by the dog. Once filled with kibble, internal apertures 40 allows a few pieces of kibble to fall into the center portion of the dispenser toy.

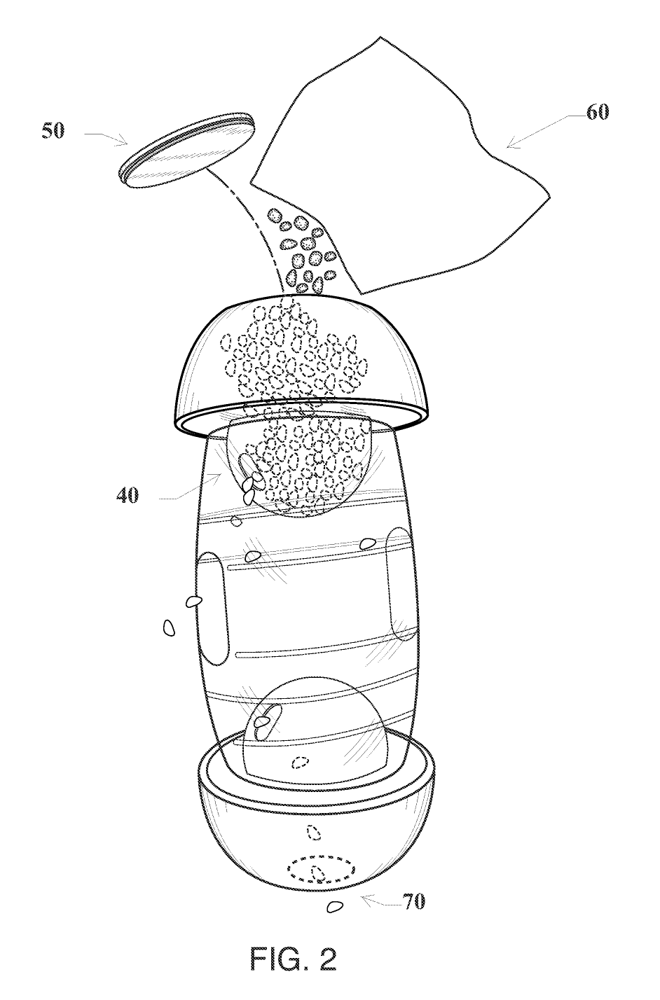

FIG. 2 shows the fill cap 50 wherein a user pours kibbles or treats 60. A few pieces of kibble can then fall from the internal aperture 40 into the clear center piece. Again, external exit apertures 30 are illustrated wherein kibble can be ejected when the dispenser toy is manipulated. Further to this Figure, the end aperture 70 is viewed and provides another exit mode for kibble.

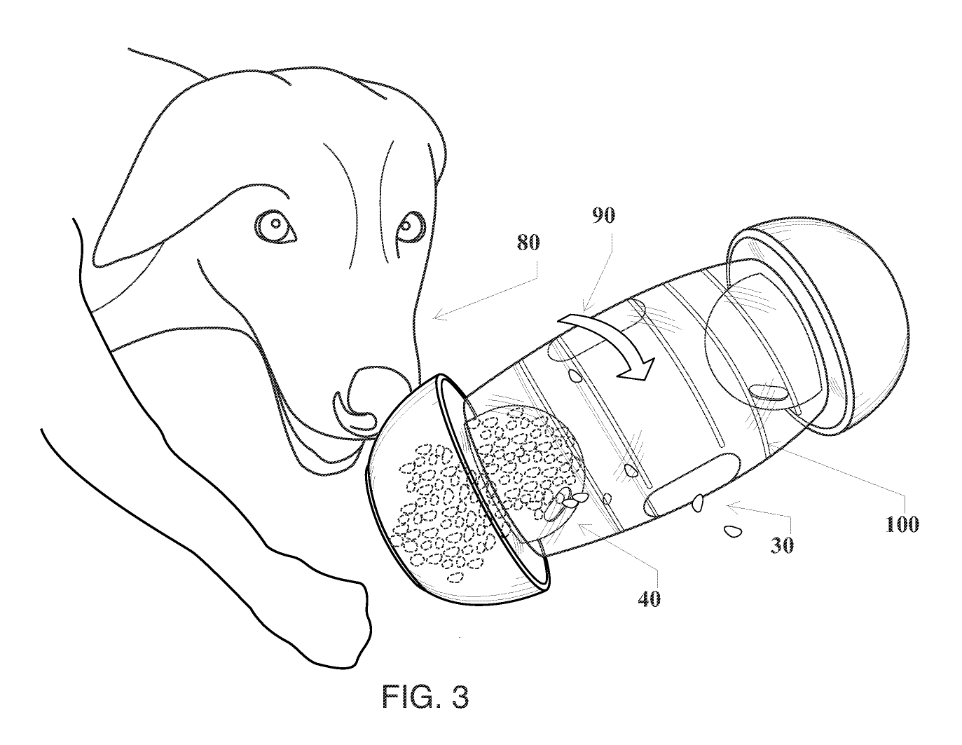

FIG. 3 illustrates a dog 80 nudging the dispenser toy. In turn the dispenser toy will rotate on a surface 90. The internal aperture 40 allows a few kibbles to be ejected into the center piece of the dispenser toy. The protruding fins 100 catch kibble pieces and allow them to slide and tumbles within the center piece as it is rolled along a surface. Finally, kibble pieces eject from the external aperture 30 and the dog can then consume the dispensed kibble.

1) A cylindrical spinning pet toy and treat dispenser comprising:
a) a clear plastic center section with raised plastic fins
b) a first and second end caps
c) filling aperture means via the first end cap
d) internal dispensing aperture
e) external dispensing apertures

2) The cylindrical spinning pet toy and treat dispenser as in claim 1 wherein the clear plastic center section has said raised plastic fins molded on the internal section of the center piece and which protrude within into the center piece wherein a food kibble will slide along the fins and tumble within the plastic center section when the toy is rolled or turned by a pet.

3) The cylindrical spinning pet toy and treat dispenser as in claim 1 wherein two end caps attach to the center section, and wherein the first end cap has a means for filling the dispenser with kibble via a removable cover piece which twists off to allow filling of kibble into the center section.

4) The cylindrical spinning pet toy and treat dispenser as in claim 1 wherein the second end cap contains a dispensing aperture whereby hole for inserted kibble is to be ejected to the outside of the dispenser for consumption by a pet when the dispenser is rolled or turned by the pet.

5) The cylindrical spinning pet toy and treat dispenser as in claim 1 wherein the internal dispensing aperture is located in the first end cap and ejects kibble into the center section of the dispenser.

6) The cylindrical spinning pet toy and treat dispenser as in claim 1 wherein the external dispensing apertures are located in the clear center section and in the second end cap and both allow for dispensing of kibble to the outside of the toy and dispenser for consumption by a pet.
